(19) United States
(12) Patent Application Publication
(10) Pub. No.: US 2024/0021101 A1
(43) Pub. Date: Jan. 18, 2024

(54) METHOD FOR FACILITATING LANGUAGE LEARNING USING A TACTILE-BASED LANGUAGE LEARNING SYSTEM

(71) Applicant: The Education University of Hong Kong, Tai Po (HK)

(72) Inventor: Keung HUNG, Tai Po (HK)

(21) Appl. No.: 18/155,910

(22) Filed: Jan. 18, 2023

(30) Foreign Application Priority Data
Jul. 18, 2022 (HK) 32022056928.1

(51) Int. Cl. G09B 21/00; G09B 19/06

(52) U.S. Cl. CPC G09B 21/004; G09B 21/007; G09B 19/06

(57) ABSTRACT

A tactile-based language learning system comprising a plurality of character units each having a tactile structure of a language character, and electronic components arrange to detect another character unit positioned adjacent to or proximate to the character unit; and a language processing module arranged to process the combination of the plurality of character units being positioned with a predetermined arrangement thereby providing audible or tactile information to the user.

### TECHNICAL FIELD

The invention relates to a system and a method for facilitating language learning for language learners, and particularly, although not exclusively, to a tactile-based language learning system for visually impaired persons.

### BACKGROUND

Visual impaired persons usually read and write languages by touch, and one of most common ways is by using the Braille system which comprises various combinations of raised dots representing the alphabet, words, punctuation, numbers.

Asian languages such as Chinese, when presented in written or printed form, is usually “represented” by combination of individual characters each having one or more strokes combining to form a word having a unique meaning, and there are more than tens of thousands of unique Chinese characters. Chinese languages can also be represented by using Braille, however only the pronunciation of the language characters may be presented.

### SUMMARY OF THE INVENTION

In accordance with a first aspect of the present invention, there is provided a tactile-based language learning system for users, including language learners and/or visually impaired persons, comprising: a plurality of character units each having a tactile structure of a language character, and electronic components arrange to detect another character unit positioned adjacent to or proximate to the character unit; and a language processing module arranged to process the combination of the plurality of character units being positioned with a predetermined arrangement thereby providing audible or tactile information to the language learners and/or visually impaired person.

In accordance with the first aspect, the language character includes an ideographic description character or a portion of the ideographic description character.

In accordance with the first aspect, each of the plurality of character units includes an alignment module arrange to detect and/or to facilitate alignment of two character units being positioned adjacent to or proximate to each other.

In accordance with the first aspect, the alignment module includes an infrared LED transmitter and receiver pair on four sides on each of the plurality of character units, wherein the signal generated by the infrared LED transmitter is detectable by the infrared LED receiver of the another character unit positioned adjacent to or proximate to the character unit.

In accordance with the first aspect, the language processing module is arranged to process the combination of the plurality of character units being positioned with the predetermined arrangement upon detecting a new combination of the plurality of character units different from a previous combination of the plurality of character units.

In accordance with the first aspect, the system further comprises a wireless communication module arranged to transmit the predetermined arrangement to the language processing module for processing of the combination of the plurality of character units being positioned with a predetermined arrangement.

In accordance with the first aspect, the wireless communication module includes a WiFi communication module provided in one or more of the plurality of character units.

In accordance with the first aspect, each of the plurality of character units further comprising a rechargeable power source arranged to energize the electronic components in each of the character units to facilitate detection and/or wirelessly transmitting the predetermined arrangement of the predetermined arrangement.

In accordance with the first aspect, one or more of the plurality of character units further comprises a feedback module arranged to provide the audible or tactile information to the language learner and/or visually impaired person.

In accordance with the first aspect, the tactile structure has a size arranged to fit with a palm of the language learner and/or visually impaired person.

In accordance with a second aspect of the present invention, there is provided a method for facilitating language learning for language learners and/or visually impaired persons, comprising the step of: providing a plurality of character units each having a tactile structure of a language character, and electronic components arrange to detect another character unit positioned adjacent to or proximate to the character unit; processing the combination of the plurality of character units being positioned with a predetermined arrangement; and providing audible or tactile information associated with the combination of the plurality of character units to the language learner and/or visually impaired person.

In accordance with the second aspect, the language character includes an ideographic description character or a portion of the ideographic description character.

In accordance with the second aspect, the method further comprises the step of providing each of the plurality of character units with an alignment module arrange to detect and/or to facilitate alignment of two character units being positioned adjacent to or proximate to each other.

In accordance with the second aspect, the alignment module includes an infrared LED transmitter and receiver pair on four sides on each of the plurality of character units, wherein the signal generated by the infrared LED transmitter is detectable by the infrared LED receiver of the another character unit positioned adjacent to or proximate to the character unit.

In accordance with the second aspect, the step of processing the combination of the plurality of character units being positioned with the predetermined arrangement is performed upon detecting a new combination of the plurality of character units different from a previous combination of the plurality of character units.

In accordance with the second aspect, the method further comprises the step of wirelessly transmitting the predetermined arrangement to an external language processing module for processing of the combination of the plurality of character units being positioned with a predetermined arrangement.

In accordance with the second aspect, the method further comprises the step of providing a WiFi communication module in one or more of the plurality of character units.

In accordance with the second aspect, the method further comprises the step of energizing the electronic components in each of the character units with a rechargeable power source to facilitate detection and/or wirelessly transmitting the predetermined arrangement of the predetermined arrangement.

In accordance with the second aspect, the method further comprises the step of providing one or more of the plurality of character units with a feedback module arranged to provide the audible or tactile information to the language learner and/or visually impaired person.

In accordance with the second aspect, the tactile structure has a size arranged to fit with a palm of the language learner and/or visually impaired person.

### BRIEF DESCRIPTION OF THE DRAWINGS

Embodiments of the present invention will now be described, by way of example, with reference to the accompanying drawings in which:

FIG. 1 is a schematic diagram showing a character unit of a tactile-based language learning system in accordance with an embodiment of the present invention, and illustration of the character unit communicating with a computer server operating as an external language processing module for processing a detection signal transmitted from the character unit;

FIG. 2A is an image showing an assembly of a tactile structure of a language character on a top surface of the character unit of FIG. 1;

FIG. 2B is an image of a housing which accommodates electronic components arrange to detect another character unit positioned adjacent to or proximate to the character unit of FIG. 1, and a power bank operating as a rechargeable power source arranged to energize the electronic components;

FIG. 3 is an illustration showing an example operation of the character unit of the tactile-based language learning system of FIG. 1, the tactile structure has a size arranged to fit with a palm of the language learner and/or visually impaired person;

FIG. 4 is an illustration showing a top perspective view, a front view, a rear view, a left side view and a right side view of the character unit of the tactile-based language learning system of FIG. 1;

FIG. 5A is an illustration showing a combination of three character units of the tactile-based language learning system of FIG. 1, wherein the character units are arranged in a first example arrangement;

FIG. 5B is an illustration showing a combination of four character units of the tactile-based language learning system of FIG. 1, wherein the character units are arranged in a second example arrangement different from the arrangement as shown in FIG. 5A;

FIG. 6A is an image showing an operation of four character units of the tactile-based language learning system being placed on a white board, and a computer interface showing a determination of the combination of the plurality of character units being positioned together; and

FIG. 6B is another image showing the left sides and the top surfaces of the four character units of the tactile-based language learning system being placed on a white board of FIG. 6A.

### DETAILED DESCRIPTION OF THE PREFERRED EMBODIMENT

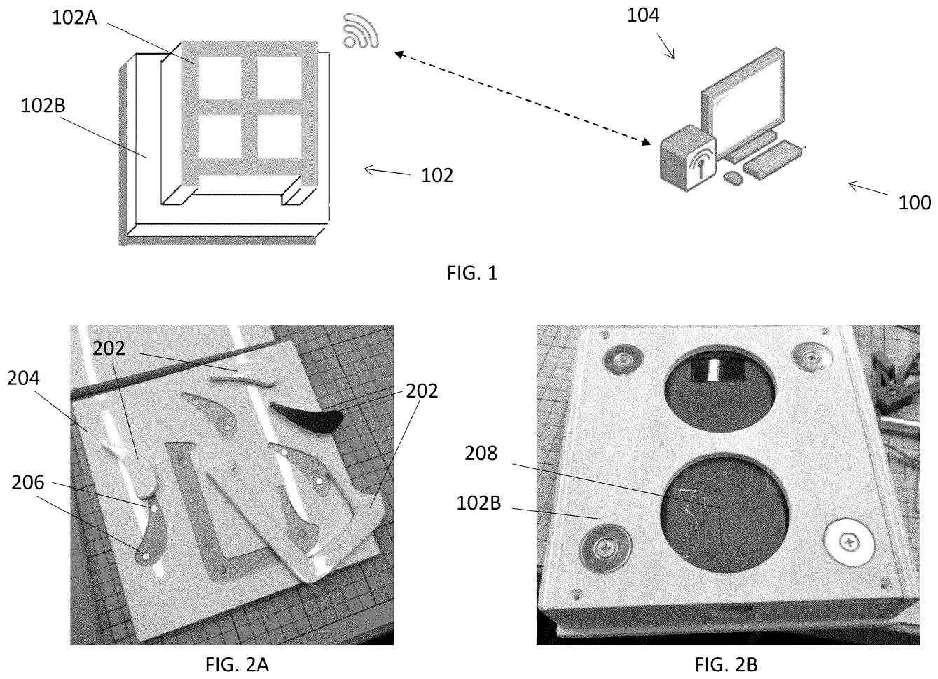

Referring to FIG. 1, an embodiment of the present invention is illustrated. This embodiment is arranged to provide a tactile-based language learning system 100 for language learners and/or visually impaired persons, comprising: a plurality of character units 102 each having a tactile structure 102A of a language character, and electronic components arrange to detect another character unit positioned adjacent to or proximate to the character unit 102; and a language processing module 104 arranged to process the combination of the plurality of character units 102 being positioned with a predetermined arrangement thereby providing audible or tactile information to the language learner and/or visually impaired person.

In this example, each of the character units 102, such as the one as shown in FIG. 1, has a substantially rectangular case or housing 102B forming a base of the character unit 102. The case 102B preferably houses a number of electronic components, such as signal transmitters, detectors, batteries, controllers and/or processing units which may cooperate to provide necessary functions associated with detecting and/or processing a combination of a plurality of character units 102 positioned proximate to each other.

Preferably, the plurality of character units 102 includes an alignment module arrange to detect and/or to facilitate alignment of two character units 102 being positioned adjacent to or proximate to each other, and also a wireless communication module arranged to transmit the predetermined arrangement to the language processing module 104 for processing the detection signal associated with the combination of the character units 102. For example, once a predetermined arrangement of two character units 102 being placed together side-by-side, one of the character units 102 may utilize a wireless communication module, such as a WiFi communication module provided in one or more of the plurality of character units 102 to communicate the detected arrangement to an external language processing module 104.

In this example embodiment, the external language processing module 104 may be implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

For example, a computer system or computer server may be implemented as an example embodiment of a system for processing the predetermined arranged of multiple character units 102. The system may comprise suitable components necessary to receive, store and execute appropriate computer instructions. The components may include a processing unit, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM), random access memory (RAM), and input/output devices such as disk drives, input devices such as an Ethernet port, a USB port, etc.

Display such as a liquid crystal display, a light emitting display or any other suitable display and communications links may also be provided. The server may include instructions that may be included in ROM, RAM or disk drives and may be executed by the processing unit. There may be provided a plurality of communication links which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server may also include storage devices such as a disk drive which may encompass solid state drives, hard disk drives, optical drives, magnetic tape drives or remote or cloud-based storage devices. The server may use a single disk drive or multiple disk drives, or a remote storage service. The server may also have a suitable operating system which resides on the disk drive or in the ROM of the server.

The computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

In addition, the character unit 102 is also provided with a tactile structure 102A of a language character, for example an ideographic description character or a portion of the ideographic description character with reference to FIG. 1. Preferably, the tactile structure 102A has a certain height from the top surface of the housing 102B such that when a user places his/her palm on the tactile structure 102A or the ideographic description character, the user will be able to feel the shape of the ideographic description character rising from the top surface of the housing 102B.

In this example, the ideographic description character is a Chinese character “ [symbol] ” (read as “tin” in Cantonese, meaning “farm” or “field”) which is essential a combination four squares placed together as shown in the figure. Without wishing to be bound by theory, an ideographic description character may be considered as a block containing graphic characters used for describing ideographs such as but not limited to Chinese, Japanese and Korean characters or words. An ideographic description character may be made up of multiple portions of the ideographic description character or ideographs arranged in specific orders or arrangement, therefore depending on how the ideographs are arranged, an ideographic description character may be composed. For example, three squares arranged together in a triangular arrangement form a Chinese character “ [symbol] ” (read as “bun” in Cantonese, meaning “rank” or “grade”).

With reference also to FIGS. 2A and 2B, there is shown in example assembly of the character unit 102. In this example the ideographic description character is a Chinese character “ [symbol] ” (read as “sum” in Cantonese, meaning “heart”). The Chinese character has four “strokes” 202 which may be separately formed by laser cutting a piece of plastic sheet with a predetermined thickness. The four “strokes” 202 of the Chinese character may be combined on a substrate or a supporting plate 204 embedding with a plurality of magnets 206 at proper positions such that when the laser cut plastic pieces are placed on the supporting plate 204 the four “strokes” 202 are securely fixed on the supporting plate 204 at their correct positions and orientations.

Alternatively, the tactile structure 102A may be ideographic description characters in other Asian languages, such as Japanese and Korean, or other language characters such as alphabets or letters of non-Asian languages, and the tactile structure 102A may be manufactured using other material as desired.

Referring to FIG. 2B, the housing 102B is large enough to accommodate a power bank 208 having a battery capacity sufficient to power up the character unit 102 for a predetermined of operation time, e.g. 24 hours after each time the power bank 208 has been fully charged. Alternatively, other types of power source such as wireless power receiving coil or external DC/AC power may be used to power up the electronic components in the character unit 102.

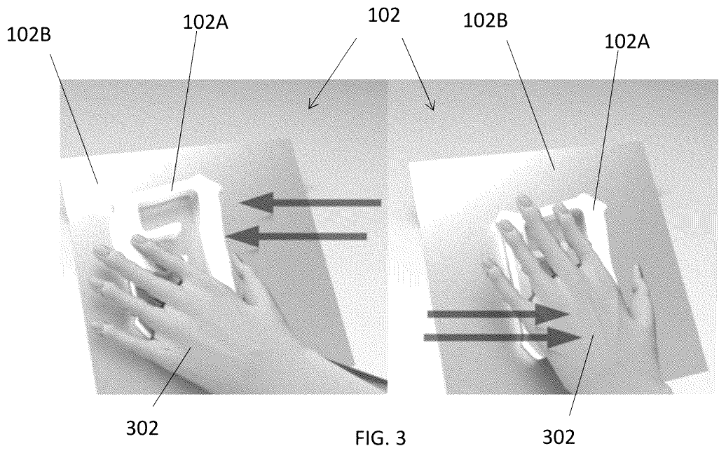

With reference to FIG. 3, the system may be used for facilitating language learning for language learners and/or visually impaired persons, for example by providing a sufficiently large tactile area which may fit in a palm 302 of an adult, so that when the language learner and/or visually impaired person put his/her palm 302 on the tactile structure 102A, the learner and/or visually impaired person may “read” the language character by feeling the shape of the language character. In addition, the tactile structure 102A may have a size preferably fitting with the palm 302 of the learner and/or visually impaired person such that the character unit 102 may be easily moved, e.g. sliding the character unit 102 placed on a surface as shown in the figure, by the learner and/or visually impaired person when the user is in touch with the tactile structure.

It should be noted that embodiments of the system for facilitating learning languages may be used and may offer an advantage to visually impaired users as well as any other language users who may or may not have any level of vision impairment. Whilst certain example features of the system may well function for users who have a vision impairment, the same features may also be used by any language learners or users of the system to learn a language and may nonetheless offer an enhanced experience. Accordingly, the system may be used by all users or language learners, including those with vision impairment or without any vision impairment.

Alternatively, the size of the tactile structure 102A and/or the housing 102B may be of a size which may fit in a palm of a child for system designed for being used by children with smaller hands.

Preferably, the alignment module includes an infrared LED transmitter and receiver pair on four sides on each of the plurality of character units, wherein the signal generated by the infrared LED transmitter is detectable by the infrared LED receiver of the another character unit 102 positioned adjacent to or proximate to the character unit.

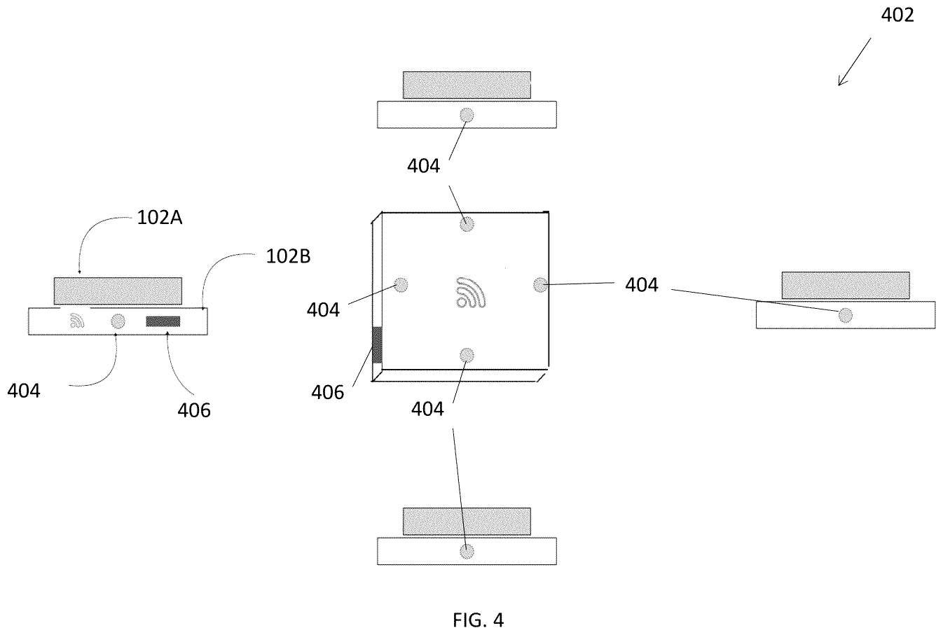

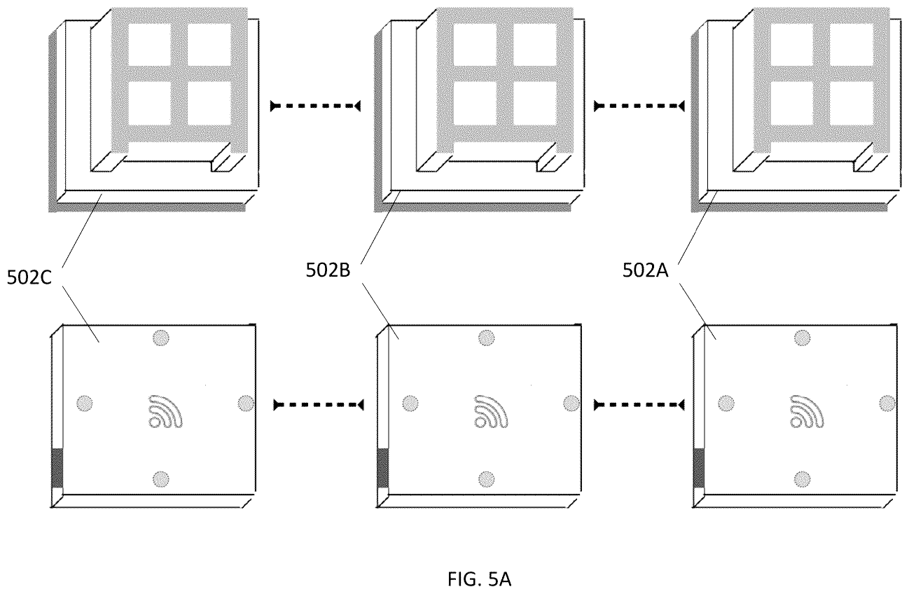

With reference to FIG. 4, there is shown an embodiment of the controller unit 402 (e.g. housed within the housing 102B) under the 3D character or the tactile structure 102A. Preferably, the controller unit 402 may be an electronic device having the plurality of electronic components housed within the rectangular block, including a controller board such as a CPU, RAM and/or flash memory; a (rechargeable) battery pack or a power bank as described above; a plurality of LEDs 404 (e.g. in the infrared wavelength) including transmitter and receiver; a WiFi communication module; and a USB connector 406 at least for charging the battery pack housed within the controller unit 402.

Preferably, the case or housing 102B is defined with apertures or transparent windows which allow optical signals passing through the sides of the housing 102B. Thus, the controller unit 402 may detect of another character units 102 placed adjacent to any one of the four sides of the controller unit 402, when the LED transmitter and receiver pair detect an alignment of two character units 102 being positioned adjacent to or proximate to each other.

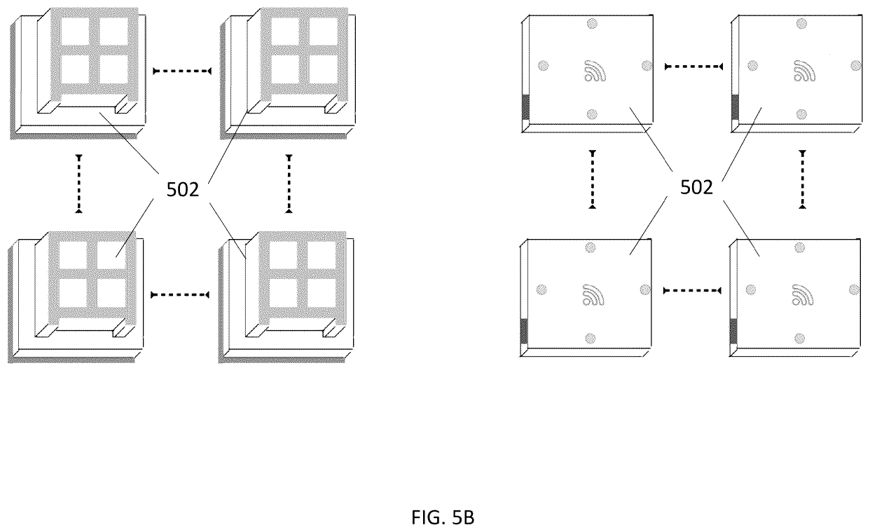

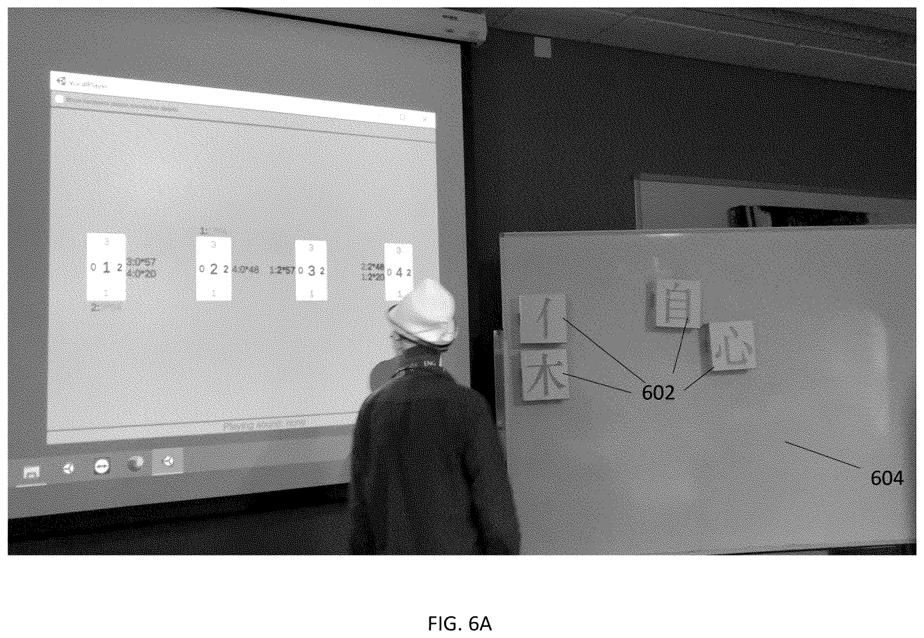

With reference to FIG. 5A, there is shown a first example arrangement in which three character units are placed side by side. In this example when the character unit 102 detect the other through the infrared led, such as the LED receiver of controller unit 502A detect the LED signal transmitted from of controller unit 502B, and also the LED receiver of controller unit 502B detect the LED signal transmitted from of controller unit 502A, the both devices may remember this arrangement.

In addition, when the LED receiver of controller unit 502C detect the LED signal transmitted from of controller unit 502B, and also the LED receiver of controller unit 502B detect the LED signal transmitted from of controller unit 502C, the both devices may remember this arrangement.

When a new relation is formed or broken, then the devices may transmit this information to the computer (such as the one in FIG. 1) through WiFi. A single connection may be established from one or more of the controller unit 502A, 502B or 502C to the computer, e.g. via direct WiFi connection or through a WiFi Router. The computer may then resemble the relation information and notify the user information or a “story” in relation to the combination of the three character units 102 placed in such an arrangement.

Preferably, the plurality of character units 102 further comprises a feedback module arranged to provide the audible or tactile information to the learner and/or visually impaired person. For example, an audio speaker may be provided in one or more of the plurality of character units 102, or a means to print out Braille which may be read by the learner and/or visually impaired person. Alternatively, the feedback module may be provided as a separate unit or may be provided in the computer for processing the arrangement of the character units.

Yet alternately, it is also possible that one of character units 102 which is the “master unit” is provided with the feedback module for notifying the user information or a story in relation to the combination of the character units 102 placed in such an arrangement. Optionally or additionally, it is also possible that only the master unit is provided with a WiFi module for transmitting the detected arrangement to the external computer via a wireless communication network.

In an alternative embodiment, the language processing module may be provided in one or more of the character units 102 thereby eliminating the need of an external computer.

With reference to FIG. 5B, there is shown a second example arrangement in which four character units 502 are placed side by side. In this example, each of the character units 502 detects two adjacent character units 502, next to two adjacent sides of the respective character unit 502. The operations of the detection according to the LED signals and the transmission of the detected arrangement is similar to the example with reference to FIG. 5A.

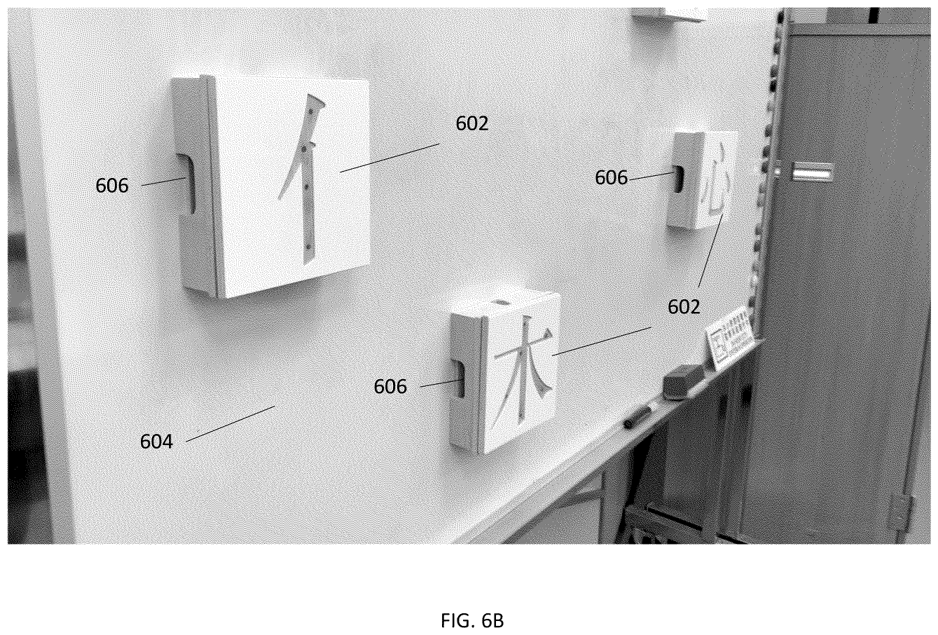

With reference to FIGS. 6A and 6B, there is shown in example operation of four character units 102 each having a language character “ [symbol] ”, “ [symbol] ”, “ [symbol] ” or “ [symbol] ”, and two Chinese characters “ [symbol] ” and “ [symbol] ” (combining to read as “yau sik” and mean “taking a rest”) may be obtained by arranging “ [symbol] ” and “ [symbol] ” side-by-side, and “ [symbol] ” and “ [symbol] ” one above another. In this example, each of the characters “ [symbol] ”, “ [symbol] ” and “ [symbol] ” represents an individual ideographic description character having unique meanings, as well as a portion of an ideographic description character as they can combine with other portions to form another Chinese character, whereas the character “ [symbol] ”, whilst having a meaning of “human”, usually form a portion of a Chinese character.

In this example 2 sets (4 pieces) of 3D characters 602 are placed on a whiteboard 604, for example by utilizing a magnetic plate secured at the bottom surface of the controller unit of the character unit 602. Referring to the figure, apart from being tactile 3D models, each character will be broken down into respective graphic components “ [symbol] ”, “ [symbol] ”, “ [symbol] ” and “ [symbol] ”, all of which are movable on the white board operating as a toolkit work surface.

Preferably, each 3D character 602 has a unique identifier, which may be encoded by each of the controller units and transmitted from the infrared LED transmitter and received by the receivers via the apertures 606 on the sides of the case.

With the arrangement as shown in FIG. 6A and FIG. 6B, no audio feedback is produced as the character units 602 are not positioned in right positions or arrangement. However, when any two 3D characters 602 are paired, which means two devices are close to each other, a signal comprised of identifiers and relative positional information is transmitted to the computer (not shown). The computer received the information from different paired 3D characters 602 and construct the topology of all the 3D characters 602. Then the computer may further process this detected arrangement, e.g. by searching this topology information from a database and find a story closely related to this topology. The story may be presented to the audience through video and audio. Different set of stories will be generated based on different combinations of the 3D characters 602.

These embodiments may be advantageous in that, the tactile-based language learning system may be implemented as a game which may be played by language learners and/or visually impaired persons so as to facilitating language learning, through ‘touch’; ‘drag’ and ‘re-arrange’ a plurality of character units 102 on a stainless steel whiteboard/table, and users may gain different information bases on different combination.

Advantageously, the tactile-based language learning system may be implemented with different functions, such as to provide a dynamic learning experience through movable characters; to provide a learning experience through story telling—sound navigation; to provide a new learning experience through touch—tactile; an easy and effective way finding system and a game play function.

With these functions, the system may be used to provide a wide variety of learning possibility
creative application; a closer interaction between the ‘teachers’ and ‘learners’; a costume made story presentation; different story bases on different characters. Moreover, specific content can be created and used for different purpose, such as for elderly, visually impaired, kids, etc.

Advantageously, the tactile-based language learning system for language learners and/or visually impaired persons may assist various language learners and/or people of visually impaired to overcome a burden of ideographic description character learning experience. The system facilitates a new learning & teaching experience through touch and sound, or an approach of learning meaning/content of different characters through game playing or puzzle mode. The system also allows creative educational approaches which create a wide variety of learning possibilities.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include tablet computers, wearable devices, smart phones, Internet of Things (IoT) devices, edge computing devices, stand alone computers, network computers, cloud based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A tactile-based language learning system comprising:
a plurality of character units each having a tactile structure of a language character, and electronic components arrange to detect another character unit positioned adjacent to or proximate to the character unit; and
a language processing module arranged to process the combination of the plurality of character units being positioned with a predetermined arrangement thereby providing audible or tactile information to the user.

2. The tactile-based language learning system in accordance with claim 1, wherein the language character includes an ideographic description character or a portion of the ideographic description character.

3. The tactile-based language learning system in accordance with claim 1, wherein each of the plurality of character units includes an alignment module arrange to detect and/or to facilitate alignment of two character units being positioned adjacent to or proximate to each other.

4. The tactile-based language learning system in accordance with claim 3, wherein the alignment module includes an infrared LED transmitter and receiver pair on four sides on each of the plurality of character units, wherein the signal generated by the infrared LED transmitter is detectable by the infrared LED receiver of the another character unit positioned adjacent to or proximate to the character unit.

5. The tactile-based language learning system in accordance with claim 3, wherein the language processing module is arranged to process the combination of the plurality of character units being positioned with the predetermined arrangement upon detecting a new combination of the plurality of character units different from a previous combination of the plurality of character units.

6. The tactile-based language learning system in accordance with claim 1, further comprising a wireless communication module arranged to transmit the predetermined arrangement to the language processing module for processing of the combination of the plurality of character units being positioned with a predetermined arrangement.

7. The tactile-based language learning system in accordance with claim 6, wherein the wireless communication module includes a WiFi communication module provided in one or more of the plurality of character units.

8. The tactile-based language learning system in accordance with claim 7, wherein each of the plurality of character units further comprising a rechargeable power source arranged to energize the electronic components in each of the character units to facilitate detection and/or wirelessly transmitting the predetermined arrangement of the predetermined arrangement.

9. The tactile-based language learning system in accordance with claim 1, wherein one or more of the plurality of character units further comprises a feedback module arranged to provide the audible or tactile information to the user.

10. The tactile-based language learning system in accordance with claim 1, wherein the tactile structure has a size arranged to fit with a palm of the user.

11. A method for facilitating language comprising the step of:
providing a plurality of character units each having a tactile structure of a language character, and electronic components arrange to detect another character unit positioned adjacent to or proximate to the character unit;
processing the combination of the plurality of character units being positioned with a predetermined arrangement; and
providing audible or tactile information associated with the combination of the plurality of character units to the user.

12. The method for facilitating language learning accordance with claim 11, wherein the language character includes an ideographic description character or a portion of the ideographic description character.

13. The method for facilitating language learning accordance with claim 11, further comprising the step of providing each of the plurality of character units with an alignment module arrange to detect and/or to facilitate alignment of two character units being positioned adjacent to or proximate to each other.

14. The method for facilitating language learning accordance with claim 13, wherein the alignment module includes an infrared LED transmitter and receiver pair on four sides on each of the plurality of character units, wherein the signal generated by the infrared LED transmitter is detectable by the infrared LED receiver of the another character unit positioned adjacent to or proximate to the character unit.

15. The method for facilitating language learning accordance with claim 13, wherein the step of processing the combination of the plurality of character units being positioned with the predetermined arrangement is performed upon detecting a new combination of the plurality of character units different from a previous combination of the plurality of character units.

16. The method for facilitating language learning accordance with claim 11, further comprising the step of wirelessly transmitting the predetermined arrangement to an external language processing module for processing of the combination of the plurality of character units being positioned with a predetermined arrangement.

17. The method for facilitating language learning accordance with claim 16, further comprising the step of providing a WiFi communication module in one or more of the plurality of character units.

18. The method for facilitating language learning accordance with claim 17, further comprising the step of energizing the electronic components in each of the character units with a rechargeable power source to facilitate detection and/or wirelessly transmitting the predetermined arrangement of the predetermined arrangement.

19. The method for facilitating language learning accordance with claim 17, further comprising the step of providing one or more of the plurality of character units with a feedback module arranged to provide the audible or tactile information to the user.

20. The method for facilitating language learning accordance with claim 11, wherein the tactile structure has a size arranged to fit with a palm of the user.
